(19) United States
(12) Patent Application Publication
(10) Pub. No.: US 2003/0109267 A1
(43) Pub. Date: Jun. 12, 2003

(54) Network element locating system

(75) Inventor: Zeljko Bulut, Whitehouse Station, NJ (US)

Correspondence Address: NORMAN P. SOLOWAY, HAYES SOLOWAY P.C., 130 W. CUSHING STREET, TUCSON, AZ, 85701, US

(73) Assignee: Innovance Networks

(21) Appl. No.: 10/020,817

(22) Filed: Dec. 12, 2001

(51) Int. Cl. H04Q 7/20

(52) U.S. Cl. 455/457; 455/456

(57) ABSTRACT

A network element locating system includes a network element locator and a network element position manager. The network element locator acquires geographical location information and stores it as position data. The network element position manger receives the position data, and provides the geographical location information of the network element in a user requested format. The acquisition of the geographical location information can be made at the time of installation of the network element, using a hand-held GPS device. Alternatively, the GPS device can be embedded in the network element. The position data is transmitted to the network element position manger on request, or whenever a certain type of fault occurs.

### FIELD OF THE INVENTION

The invention resides in the field of optical telecommunications networks, and is directed in particular to a network element locating system

### BACKGROUND OF THE INVENTION

Modern networks are comprised of heterogeneous network elements (NEs), the physical connections between the NEs, and the software used to send, receive and route data. As competition among telecommunications vendors has grown, so has the size, complexity of modern communications networks. These complex communications networks, which may span thousands of miles of territory, can, and frequently do, contain thousands of different network elements of various types, made by different manufacturers, and using different communications protocols.

Managing these large and complex networks presents substantial challenges. It is known to provide the network with a centralized network management tools, which collects real time information regarding the status of the network elements and systematize this knowledge such that common problems can be detected, isolated and repaired, either automatically or by the maintenance personnel. The intent of the network management tools is to facilitate the management of the network elements by providing a centralized view of the network, as well as to enable correlation of events and conditions that span the network elements and sub-networks.

An important aspect of a network management system (NMS) is the way this information is presented to the user and the degree of interaction permitted between the user and the network, in other words, the network-user interface. In general, the user interface resides at the client terminal and is adapted to communicate with the reminder of the system. Network information is presented on a screen (graphical user interface or GUI) using icons, and the user has the ability to select additional information about a particular object model, including object models of network equipment and connectivity between the equipment, hopefully in a clear and well-organized, condensed way.

However, only certain problems may be fixed from the network management site, such as shutting down an overheating element, or rerouting traffic away from a malfunctioning network element. More often, maintenance crews need to be deployed at the site of the fault. One of the most fundamental challenges in such a scenario is the identification and accurate representation of the condition (or state) of the network. Equally important is to determine the geographical location of the faulted network elements with as much as possible accuracy, so that the maintenance crew can be promptly deployed at the respective site.

Currently, the identity of all network elements is manually entered at installation. Consequently, when a network element is either added or deleted, each of the elements would have to be manually updated with the identity of the element or elements being added or deleted. Additionally, when adding a network element, all the identity information of the other elements in the network would have to be manually inputted into the new network element. Such manual inputting of the identity information into the network elements is not only time consuming, but prone to errors. Another shortcoming of the existing network management systems is that physical records of the network element identity information had to be maintained in order to know the configuration of the network elements.

Some network management systems use bitmap background maps which provide a general view of the network element placement (geographical position) and connectivity. In order to show the position of the network elements on a bitmap, every NE needs to be positioned manually on such maps, which is not an easy operation. Also, the icon for each NE needs to be anchored to the map to avoid any undesired displacement on the map. These maps are not standardized and often very rudimentary, giving an approximate address for the nodes (sites), and no specific address for the network elements themselves.

Furthermore, when a new user workstation is provided, the setup has to be saved and ported to the new user manually. As indicated above, these setup procedures are time and labor consuming, leading to an increase in overall installation and setup time, which is not acceptable to most users.

Another disadvantage of the bitmaps is that they require a large memory area. In addition, the current NMS's are not provided with zoom-in/out capabilities, so that it is not possible to obtain position details on the bitmaps.

### SUMMARY OF THE INVENTION

It is an object of the invention to provide network element positioning and tracking system for managing position information of network elements, which obviates or mitigates at least one of the disadvantages of the existing systems. In accordance with an aspect of the invention, there is provided a network element locator for a network element (NE) of a communication network. The network element locator comprises means for storing position data reflecting the current geographical location of said NE; and means for transmitting said position data over said network in response to a request for position reporting.

In accordance with another aspect of the invention, there is provided a network element position manager for a communication network of the type having a user-network interface for monitoring and controlling a plurality of network elements (NEs) of said network. The position manager comprises means for transmitting a position information request over said network; and means for converting said position data into user-format position information.

In accordance with another aspect of the invention, there is provided a method for specifying the position of a network element in a communication network. The method comprises storing position data of said network element at said network element (NE); transmitting said position data to a remote location on request; specifying a user-formatted information for reporting said position data; and providing said position data to said user as said user-formatted information.

Advantageously, the invention enables efficient management of position information of network elements, and allows users to easily locate the network elements. The system also provides real time information on the location of a faulty network element for allowing fast deployment of the maintenance crews for repair/replacement.

The system of the invention can be applied to any non-mobile piece of equipment such as transport equipment, metro equipment, access equipment, digital subscriber line (DSL) modems, etc. The term “network element” of a communication network also includes such non-mobile pieces of equipments in the context of the purpose of the invention.

The position information can be provided as a text file, or/and on a digital map. The information may also include directions to the site of the network element in question.

In addition, if a network element is removed for repair and is thereafter reconnected into the network, the position data for the respective NE is automatically updated to indicate the new location.

Other aspects and features of the present invention will be readily apparent to those skilled in the art from a review of the following detailed description of preferred embodiments in conjunction with the accompanying drawings.

### BRIEF DESCRIPTION OF THE DRAWINGS

The foregoing and other objects, features and advantages of the invention will be apparent from the following description, as illustrated in the appended drawings, where:

FIGS. 1A and 1B are examples of digital maps showing the location of a network element on the US map of FIG. 1A, and on the city map of FIG. 1B;

FIG. 2 is a block diagram of the network element locating system; and

FIG. 3 is a flowchart showing operation of the network element locating system.

### DETAILED DESCRIPTION OF THE PREFERRED EMBODIMENTS

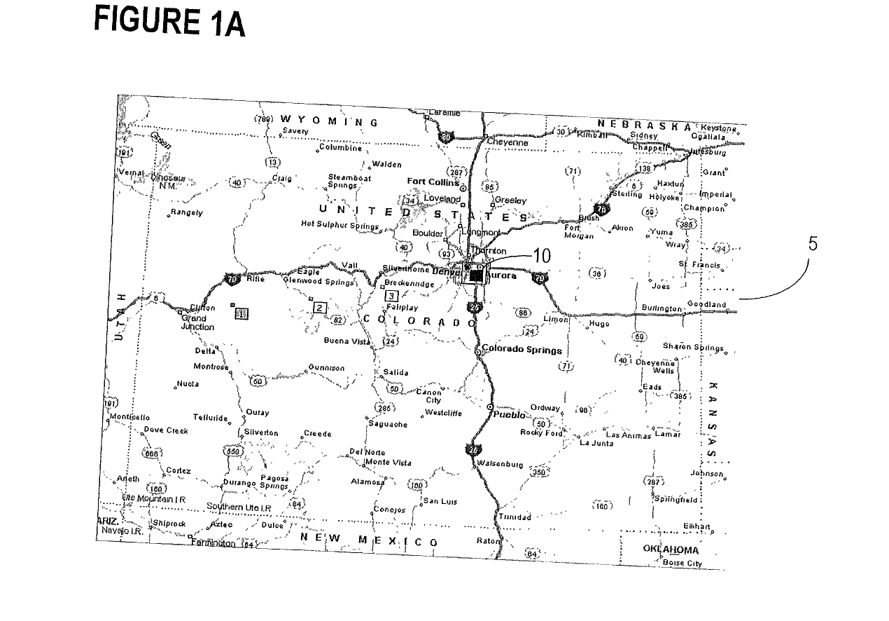

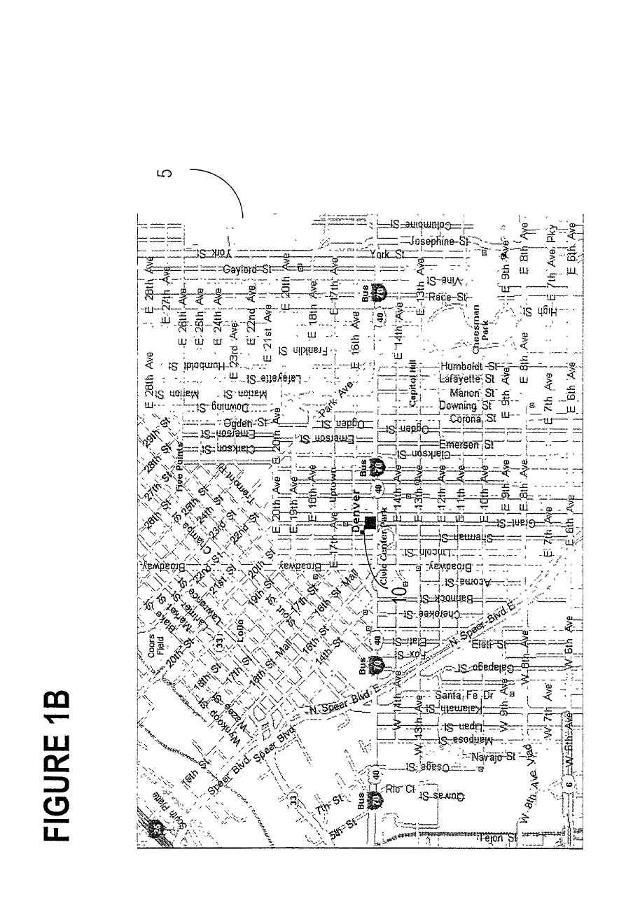

FIGS. 1A and 1B are examples of digital maps showing the location of a network element (NE) on the US map in FIG. 1A, and on the city map in FIG. 1B. The digital maps used by the NE locating system could be for example from Microsoft Trips and Streets application or the like. This type of maps offers worldwide scalability, which alleviates the need for multiple separate bitmaps. They also offer zoom in/out capabilities, giving for example country-level details within a country/continent, as shown in FIG. 1A, or details at street level granularity, as shown in FIG. 1B.

Furthermore, these digital and vector maps can be used on any platform and any terminal, so that no specific set-up is necessary. Additional service can be provided using the inherent driving directions capability that some of these applications have.

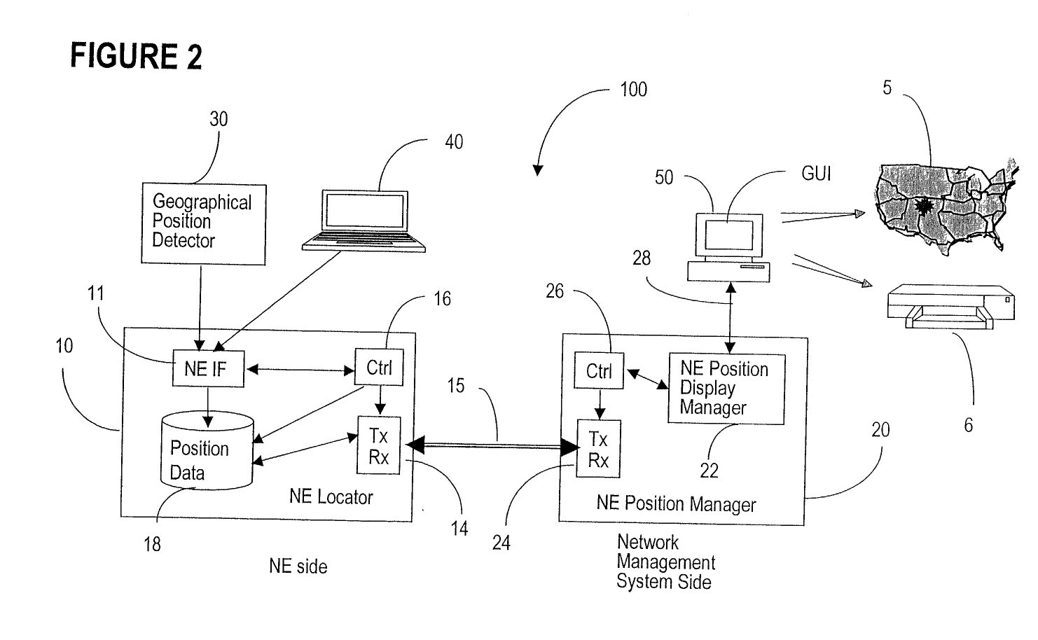

FIG. 2 is a block diagram of the network element locating system in accordance with an embodiment of the present invention. This figure illustrates a network element locator 10, provided at a network element (NE), and a location manager 20, part of the network management system (N MS). It is to be understood that only the units pertinent to detecting the network element geographical position are shown on this figure, other units related to traffic transmission/reception at the NE and NMS sides are not the object of the invention and therefore are not illustrated. It is also to be noted that FIG. 2 shows only one network element locator 10; similar configurations may be used for all network elements controlled by network management system.

Each network element stores its geographical location information in a management information database (MIB) 18, inherently present at all managed objects of a network. Alternatively, a dedicated register may be used for this information, but the MIB variant is preferable. The geographical location information is stored as position data, and may include any information that fully identifies the location of the network element. Thus, in the case when the site is in a populated area, the position data may include the postal address, or otherwise, it can include the country, county, and/or the geographical coordinates (e.g. in the case of optical amplification huts). Furthermore, the position data may include rack and shelf location of all card-packs of the network element.

The current geographical position information of network element locator 10 can be obtained using a geographical position detector 30 during installation of the network element at the respective site. This could be for example a GPS (geo-positioning system) hand-held device, which is readily available at an acceptable price (less than $100). As NEs are stationary, geographical position detector 30 can be portable, and carried by the crew installing the NE.

Alternatively, device 30 can be built-in the NE locator 10; this option will not increase the cost of the NE by much, but will provide the NE with means for automatically updating the position data whenever the NE is moved to another location. The geographical position information can alternatively be entered manually, as shown at by input/output terminal 40.

In general, all network elements are provided with interfaces as shown at 11 for setting some NE provisioned parameters. This interface can also be used for entering the position data into memory 18 from device 30 or/and 40.

The position data is maintained in the database 18 until the network element locator 10 is removed from the network, for example in the case that it is removed for repair. If thereafter the NE having NE location manager 10 is deployed at another site, the new position data will be entered during installation at that site.

Modern networks are provided with a signaling and control layer that enable data communication between the network elements and the network management system. The data transmitted over this network from the NE locator 10 to NE location manager 20 are for example device alarms, and the data transmitted from the NMS to the NEs are control signals. Different manufacturers frequently use different protocols and commands for managing their network elements, such as Q3, TL-1 or SNMP. To enable this signaling and control communication, the network elements are provided with a dedicated transceiver (a transmitter/receiver pair), as shown at 14. Thus, the position data can be multiplexed with the signaling and control data and transmitted from the network element locator 10 to NE location manager 20 over the control and signaling network 15, using transceivers such as 14.

On the transmit side of transmitter 14, unit 16 controls position data transfer between the database 18 and the transmitter side of transceiver 14. On the receive side, controller 16 detects a request for position identification received from the NE location manager 20 and operates the NE to extract the position data from database 18 and prepare it for transmission. Alternatively, the NE 10 may automatically transmit its position data whenever the NMS connects to it. Still further, the position data may be sent automatically whenever the NE issues specific types of alarms. The alarm information sent to NMS can also contain the position data. Controller 16 also instructs position detector 30 to establish the geographical position of the NE for the built-in variant. Such a request can be issued automatically whenever the NE is powered-up. Other events can be setup to trigger position data collection. Controller 16 may be provided with one or all of the above options.

At the NMS side, the reverse operations are taking place. Namely, the receiver side of a transceiver 24 detects the position data received from NE 10, and a position display manager 22 provides it to the user-network interface UNI 28. The display manager 22 processes the data to present it in an appropriate format on graphical user interface (GUI) 50, also called here as user-format position information. As discussed above in connection with FIGS. 1A and 1B, the position data could be translated into an icon placed in the correct position on a digital map 5, or may be presented as a text file indicating the position of the NE 10 on the screen or printed on a printer 6. The user can zoom-in so as to obtain street-level details.

On the transmit side, controller 26 can be set to request the geographical location information at preset intervals, or in response to requests by the user, over UNI 28.

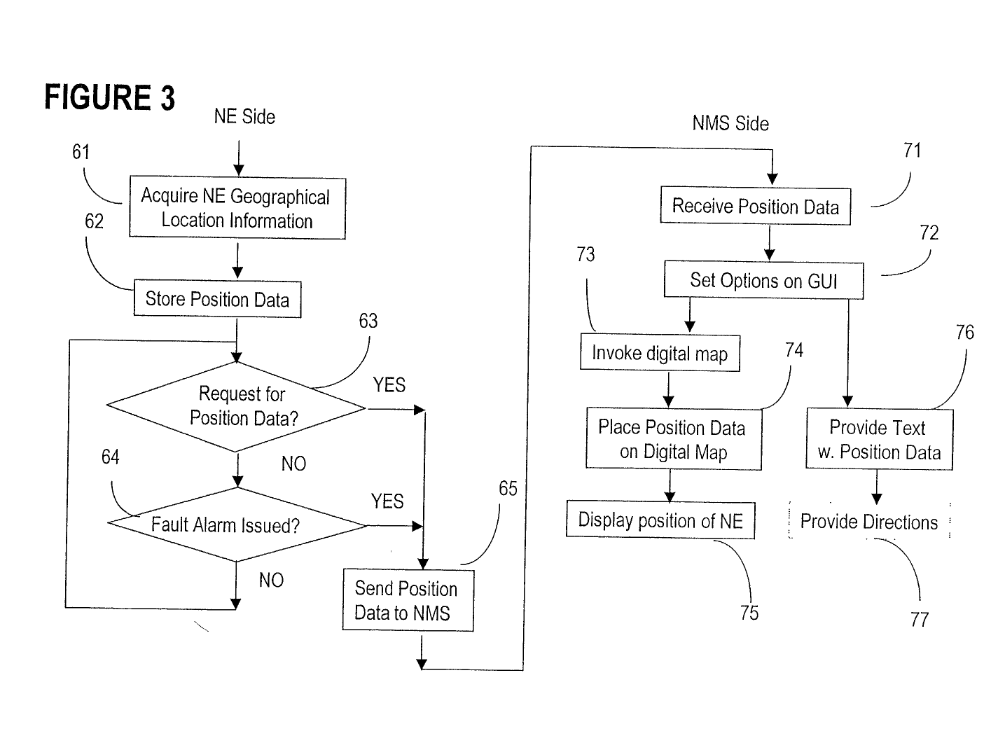

Controller 26 invokes the digital map 5. The digital map 5 is typically installed in the NMS. Alternatively, the NMS may retrieve the digital map 5 over the Internet to use Web services, such as Yahoo maps. FIG. 3 is a flowchart showing operation of the network locating and tracking system. It shows the operations taking place at the NE side on the right side of the flowchart, and the operations taking place at the NMS side on the right side. Thus, the NE acquires the geographical location information, step 61, using preferably GPS device 30, or using a terminal such as a laptop/notebook 40 for manual input of this information and stores in memory 18 as shown at step 62. NE locator 10 transmits its position data to NE location manager 20, step 65, whenever a request for position data is received, step 63, or whenever the NE issues a specified type of alarm, step 64. The position data may be stored in the memory 18, until the network element is relocated in the network. The old position data, together with the reason(s) of relocation may be kept in the memory 18, for use in e.g. various statistics equipment inventory, etc.

Network element location manager 20 receives the position data, as shown in step 71. The user sets the options on the GUI 50, regarding e.g. the type of display for the position data, the amount of geographical position information to be presented, as shown in step 72. One option is to show the NE on the map, in which case a digital map 5 is invoked in step 73, and the position data is mapped on the map, step 74, and presented to the user, step 75. If the user wishes to have the information in a text format, the NE location manager 20 may provide a printed version of the coordinates, which may include details such as a ZIP code, street number, floor, as shown in step 76. If required, driving directions can be obtained as shown in step 77.

It is to be noted that the position data can be presented to the user using other means, such as for example audio data. This can be also transmitted to the maintenance crew directly so that the crew is dispatched immediately in case of a fault. There are numerous other options to present this information; of importance is that the information on NE position is immediately available so as to be used as needed.

I claim:

1. A network element locator for a network element (NE) of a communication network, comprising:
means for storing position data reflecting the current geographical location of said NE; and
means for transmitting said position data over said network in response to a request for position reporting.

2. A network element locator as claimed in claim 1, wherein said means for transmitting comprises a receiver for receiving said request, a transmitter for transmitting said position data and control means for controlling transfer of said position data from said means for storing, said receiver, and said transmitter.

3. A network element locator as claimed in claim 1, wherein said position data comprises NE identification and the current geographical coordinates of said NE.

4. A network element locator as claimed in claim 1, wherein said position data comprises NE identification and postal address of the location of said NE.

5. A network element locator as claimed in claim 4, wherein said position data comprises NE identification, the postal address of a network site including said NE, and the place of said NE at said site.

6. A network element locator as claimed in claim 5, wherein said position data further includes rack and shelf location of all card-packs of said NE.

7. A network element locator as claimed in claim 1 further comprising an interface for receiving geographical position information, converting it into said position data and providing said position data to said means for storing.

8. A network element locator as claimed in claim 7, further comprising means for acquiring said geographical location information and transmitting same to said NE interface.

9. A network element locator as claimed in claim 8, wherein said means for acquiring is a GPS geographical position detector embedded into said network element locator.

10. A network element locator as claimed in claim 1, wherein said means for storing comprises a dedicated memory element.

11. A network element locator as claimed in claim 1, wherein said means for storing comprises a field in the management information database (MIB) of said NE.

12. A network element locator as claimed in claim 2, wherein said receiver and transmitter are connected over a signaling and control layer of said network.

13. A network element position manager for a communication network of the type having a user-network interface for monitoring and controlling a plurality of network elements (NEs) of said network, said position manager comprising:
means for transmitting a position information request over said network; and
means for converting said position data into user-format position information.

14. A network element position manager as claimed in claim 13, wherein said means for transmitting comprises a transmitter for transmitting said position information request, a receiver for receiving said position data over said network, and control means for controlling transfer of said position data from said receiver to said position display manager.

15. A network element position manager as claimed in claim 13, wherein said user-formatted information comprises a digital map with an icon representing a network element, said icon being placed on said map in a location according to said position data.

16. A network element position manager as claimed in claim 13, wherein said user-formatted information comprises a text file providing a postal address and the identification of a network element at said postal address.

17. A method for specifying the position of a network element in a communication network, comprising:
storing position data of said network element at said network element (NE);
transmitting said position data to a remote location on request;
specifying a user-formatted information for reporting said position data; and
providing said position data to said user as said user-formatted information.

18. A method as claimed in claim 17, wherein said step of storing comprises:
during installation of said NE, obtaining said position data from a geographical position detector and storing said position data in a storing means; and
updating said position data in said storage means whenever said NE is displaced to another site.

19. A method as claimed in claim 17, wherein said step of transmitting comprises;
from a network element locator manager, transmitting a request for position reporting to said NE; and
from a NE locator transmitting said position data from said network element to a network management system.

20. A method as claimed in claim 17, wherein said step of specifying comprises:
instructing a NE display manager over a user-network interface of the presentation set-up for said user-formatted information;
converting said position data into said user-formatted information according to said presentation setup.

21. A method as claimed in claim 20, wherein said step of converting comprises invoking a digital map and associating said position data with said corresponding geographical position information received with said position data.

22. A method as claimed in claim 17, wherein said step of transmitting comprises automatically transmitting said position data whenever said NE generates an alarm.
